(19) United States
(12) Patent Application Publication
(10) Pub. No.: US 2026/0275113 A1
(43) Pub. Date: Sep. 17, 2026

(54) SURFACE-MODIFIED NANOSHEETS AND COATINGS

(71) Applicant: KEIO UNIVERSITY, Tokyo (JP)

(72) Inventors: Yuya OAKI, Yokohama-shi (JP); Yuka KITAMURA, Yokohama-shi (JP); Hisafumi SUDO, Yokohama-shi (JP)

(73) Assignee: KEIO UNIVERSITY, Tokyo (JP)

(21) Appl. No.: 19/568,001

(22) Filed: Mar. 16, 2026

(30) Foreign Application Priority Data
Mar. 14, 2025 (JP) 2025-041869

(51) Int. Cl. C09D 1/00; C09D 7/20; C09D 7/40; C09D 7/63; C09D 7/80

(52) U.S. Cl. CPC C09D 1/00; C09D 7/20; C09D 7/63; C09D 7/70; C09D 7/80

(57) ABSTRACT

A novel flake including a nanosheet, which is capable of forming a smooth and thin coating; a coating including the flake; and a method for producing the coating. Provided is a flake containing a composite that contains a clay mineral and an amine, and having a thickness of 10 nm or less.

### TECHNICAL FIELD

The present disclosure relates to a nanosheet and a coating including the nanosheet.

### RELATED ART

When guest organic molecules are introduced between layers of a substance having a layered structure similar to graphite (host layers), and the obtained composite is dispersed in a solvent, a nanosheet material having a surface modified with the guest molecules and a thickness of one to ten atomic layers is obtained.

For example, JP2006-069802A discloses an inorganic/organic composite nanosheet having a sheet-like shape and a thickness on the order of nanometers, wherein the lengths of two sides among three sides are 0.1 to 2 μm, the length of the remaining side is 1 to 3 nm. In this composite nanosheet, the inorganic part and the organic part are covalently bonded, and the composition is represented by formula RhM6/iSijOk(OH)I, wherein R represents an organic group, M represents at least one element selected from Mg, Al, and Fe, 0.1≤h≤1, i represents the valence of the element M, 2≤j≤4, 6≤k≤10, and 2≤I≤6.

Haraguchi et al., Advanced Materials Interfaces 2022, Volume 9, Issue 25 2201111 discloses that a thin film having a thickness of about 100 nm and exhibiting light interference in the visible region can be obtained by drop casting an aqueous dispersion of a composite material composed of niobate (host) and 4-(aminomethyl)benzonitrile (guest).

### SUMMARY OF INVENTION

According to Y Haraguchi, et al. (ibid.), niobic acid nanosheets can form a smooth coating, which exhibits thin-film interference; however, it was unclear under what conditions such a coating is formed.

An object of the present disclosure is to provide a novel nanosheet capable of producing a smooth and thin coating; a coating containing the nanosheet; and a method for producing the coating.

For example, the present disclosure encompasses the subject matter described below.

### Item 1.

A flake comprising a composite that contains a clay mineral and an amine, and having a thickness of 10 nm or less.

### Item 2.

The flake according to Item 1, wherein the flake is a nanosheet.

### Item 3.

The flake according to Item 1, wherein the amine comprises an amine selected from the group consisting of an optionally substituted benzylamine, an optionally substituted alkylamine, an optionally substituted dialkylamine, an optionally substituted aminoalkylimidazole, an optionally substituted aminoalkylphenol, an optionally substituted amino alcohol, and salts of any of the foregoing.

### Item 4.

The flake according to Item 1, wherein the clay mineral comprises clay.

### Item 5.

A coating comprising the flake according to any one of Items 1 to 4.

### Item 6.

The coating according to Item 5, wherein the coating has a root mean square height of 0.50 μm or less.

### Item 7.

A method for producing a coating, comprising preparing a dispersion comprising a plurality of flakes according to any one of Items 1 to 4 dispersed in a solvent, and applying the dispersion to a base material.

### Item 8.

The method according to Item 7, wherein the applying comprises applying by drop casting, spin coating, dip coating, spray coating, or bar coating.

### BRIEF DESCRIPTION OF DRAWINGS

FIG. 1 shows an illustration of the production of a layered organic-inorganic composite, a nanosheet, and a coating.

FIG. 2 shows XRD of clay before and after incorporation of a guest compound.

FIG. 3 shows TG results the clay before and after incorporation of the guest compound.

FIG. 4A-4D shows the lateral size of exfoliated C₁₄-Clay: FIG. 4A is a histogram of the size determined by DLS. FIG. 4B is a TEM image. FIG. 4C is a histogram of the lateral size determined from the TEM results (logarithmic scale on the x-axis). FIG. 4D is a histogram of the lateral size determined from the TEM results (linear scale on the x-axis).

FIG. 5A shows an AFM image of the exfoliated C₁₄-Clay:.

FIG. 5B is a histogram of the thickness of the exfoliated C₁₄-Clay:(number of measurements n=106).

FIG. 6A-6E shows a film coated by spray with C₁₄-Clay nanosheets dispersed in methanol: FIG. 6A camera image; FIG. 6B contact angle measurement; FIG. 6C confirmation of structural color with an optical microscope; FIG. 6D LM image; and FIG. 6E SEM image.

FIG. 7A-7E shows a film coated by spray with 45 mg of C₁₄-Clay nanosheets dispersed in 3 mL of methanol: FIG. 7A camera image; FIG. 7B contact angle measurement; FIG. 7C confirmation of structural color with an optical microscope; FIG. 7D LM image; and FIG. 7E SEM image.

FIG. 8A-8C shows films obtained by drop casting pure water-exfoliated Guest-Clay: FIG. 8A 4-cyanobenzylamine hydrochloride (NTBA); FIG. 8B dioctylamine (DOA); and FIG. 8C stearylamine (C₁₃—NH₂). For each of the films FIG. 8A to FIG. 8C, FIG. 8A is an optical microscope image, FIG. 8B is an LM image, and FIG. 8C is an SEM image.

FIG. 9A-9C shows films obtained by drop casting pure water-exfoliated Guest-Clay: FIG. 9A tetradecylamine (C₁₄—NH₂); FIG. 9B 1-(3-aminopropyl)imidazole (API); and FIG. 9C 4-fluorobenzylamine (FBA). For each of the films FIG. 9A to FIG. 9C, FIG. 9A is an optical microscope image, FIG. 9B is an LM image, and FIG. 9C is an SEM image.

FIG. 10A-9C shows films obtained by drop casting pure water-exfoliated Guest-Clay: FIG. 10A 4-aminomethylphenol (OHBA); FIG. 10B diethanol amine (DEA); and FIG. 10C no guest. For each of the films FIG. 10A to FIG. 10C, FIG. 10A is an optical microscope image, FIG. 10B is an LM image, and FIG. 10C is an SEM image.

### DESCRIPTION OF EMBODIMENTS

As used herein, the terms “include,” “contain,” and variations thereof express concepts that encompass all of “comprise,” “consist essentially of,” and “consist of.”

Within the numerical ranges described stepwise herein, the upper or lower limit of a range at one step may be arbitrarily combined with the upper or lower limit of a range at another step. In addition, within the numerical ranges described herein, the upper or lower limit of a range may be replaced with a value shown in the examples, or a value that can be unambiguously derived from the examples. Further, as used herein, a numerical range defined by “A to B” is intended to encompass A and B as the lower and upper limits, respectively, and all values therebetween.

As used herein, the term “nanosheet” refers to a substance obtained by exfoliating a layered structure, which has a two-dimensional anisotropic shape with a thickness of a single layer to several tens of layers (e.g., about 20 layers), a thickness (t[nm]) of 10 nm or less, and a length-to-thickness ratio (L/t) of 5 or more, where L [nm] is the length perpendicular to the thickness.

As used herein, the term “structural color” refers to a color that appears due to strong reflection of specific light.

As used herein, the term “angular dependence” of the structural color indicates that the observed color varies depending on the viewing angle.

Embodiments encompassed by the present disclosure will be described in further detail below. The embodiments described below are merely examples of representative embodiments of the present disclosure, and are not intended to limit the scope of the invention.

The present disclosure provides a flake containing a composite that contains a clay mineral and an amine, and having a thickness of 10 nm or less. The composite that contains a day mineral and an amine may be a composite consisting of a clay mineral and an amine or may be a composite including one or more substances (e.g., one or more elements or compounds) in addition to the day mineral and the amine. Preferably, the flake is a nanosheet.

The present inventors controlled the conditions to obtain the nanosheet, and successfully synthesized a surface-modified nanosheet having a thickness of about 10 nm or less.

The clay mineral contains an inorganic mineral having a layered structure. Examples of clay minerals include smectite (including bentonite and montmorillonite produced therefrom), kaolinite, sericite, illite, glauconite, chlorite, talc, zeolite, vermiculite, and combinations of any of the foregoing.

Preferably, the clay mineral includes bentonite, and more preferably includes montmorillonite. Montmorillonite has crystal layers with a sheet-like structure, and is advantageous in that, upon addition of water, the interlayer spacing expands and montmorillonite swells, causing exfoliation of the crystal layers, and a viscous colloidal dispersion is thus obtained.

In a preferred embodiment, the day mineral includes a crystalline clay mineral having an average thickness of less than 10 nm. In another preferred embodiment, the clay mineral includes a crystalline day mineral having an average thickness of 5 nm or less. In a preferred embodiment, the clay mineral includes crystalline montmorillonite having an average thickness of 5 nm or less. In a preferred embodiment, the amount of montmorillonite in the clay mineral is 50 mass % or more, 60 mass % or more, 70 mass % or more, 80 mass % or more, or 90 mass % or more.

The amine is an organic amine having a skeleton containing carbon atoms. Examples of amines include an amine selected from the group consisting of optionally substituted benzylamines, optionally substituted alkylamines, optionally substituted dialkylamines, optionally substituted aminoalkylimidazoles, optionally substituted aminoalkylphenols, optionally substituted amino alcohols, and salts of any of the foregoing. When benzylamines, alkylamines, dialkylamines, aminoalkylimidazoles, aminoalkylphenols, amino alcohols, or salts of any of the foregoing have substituents, examples of substituents of these amines include, but are not limited to, cyano groups, hydroxyl groups, vinyl groups, alkyl groups (e.g., C1-C6 alkyl groups), phenyl groups, alkoxy groups (e.g., C1-C6 alkoxy groups), carbamoyl groups, alkanoyl groups, alkylcarbonyloxy groups (e.g., C1-C6 alkylcarbonyloxy groups), alkoxycarbonyl groups (e.g., C1-C6 alkoxycarbonyl groups), nitro groups, fluorine, and halogen atoms (e.g., chlorine and bromine).

In a preferred embodiment, the amine includes one or more amines selected from the group consisting of optionally substituted benzylamines, optionally substituted alkylamines in which the alkyl group has 3 to 18 carbon atoms, optionally substituted dialkylamines in which the alkyl group has 3 to 18 carbon atoms, optionally substituted aminoalkylimidazoles in which the alkyl group has 1 to 18 carbon atoms, optionally substituted aminoalkylphenols in which the alkyl group has 1 to 18 carbon atoms, optionally substituted C3-C18 amino alcohols, and salts of any of the foregoing.

The alkylamines are preferably alkylamines in which the alkyl group has 6 to 14 carbon atoms. The alkyl group may be linear or branched.

The dialkylamines are preferably dialkylamines in which each alkyl group has 6 to 14 carbon atoms. Each alkyl group may be linear or branched.

The aminoalkylimidazoles are preferably aminoalkylimidazoles in which the alkyl group has 1 to 14 carbon atoms. The alkyl group may be linear or branched.

The aminoalkylphenols are preferably aminoalkylphenols in which the alkyl group has 1 to 14 carbon atoms. The alkyl group may be linear or branched.

The amino alcohols are preferably amino alcohols in which the alkenyl group (or each alkenyl group when there are multiple alkenyl groups) has 6 to 14 carbon atoms.

When the amine is in the form of a salt, it may be an acid salt including, but not limited to, hydrochloride, sulfate, nitrate, acetate, and the like.

In a preferred embodiment, the amine includes 4-cyanobenzylamine hydrochloride, dioctylamine, stearylamine, tetradecylamine, 1-(3-aminopropyl)imidazole, 4-fluorobenzylamine, 4-(aminomethyl)phenol, or diethanol amine.

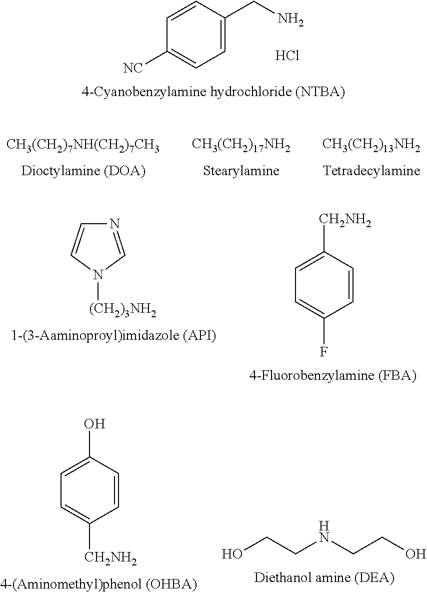

In an embodiment, the flake of the present disclosure excludes a nanosheet containing a composite of clay and tetradecylamine. In another embodiment, the flake of the present disclosure excludes a nanosheet containing a composite of clay and an alkylamine.

The composite that contains a clay mineral and an amine is an organic-inorganic composite in which an amine (guest), which is an organic molecule, is intercalated into a clay mineral (host) having a layered structure.

In the composite containing a clay mineral and an amine, the ratio of the clay mineral to the amine is not particularly limited. For example, the molar ratio of the clay mineral CEC (in milliequivalents) to the amine (in moles) is 1:1.0 to 1:2.0.

The flake of the present disclosure has a thickness of 10 nm or less, and is suitable to form a smooth and thin coating. The thickness of the flake can be measured by an atomic force microscope (AFM).

The composite that contains a clay mineral and an amine is produced by the following steps. First, a clay mineral is mixed with a solvent to produce a dispersion of the clay mineral. Mixing the clay mineral with the solvent causes the clay mineral to swell. The solvent may contain water or an organic solvent, preferably water, but is not limited thereto. Meanwhile, an amine is mixed with an acid in a solvent to produce a guest solution. The solvent may contain water or an organic solvent, preferably water, but is not limited thereto. The acid may be an inorganic acid or an organic acid, and examples include hydrochloric acid, nitric acid, and sulfuric acid. Next, the guest solution of the day mineral and the dispersion are mixed. Preferably, the mixture is stirred while heating. Subsequently, the mixture is centrifuged to obtain a composite containing a day mineral and an amine as a sediment. Formation of the composite can be confirmed from an increase in interlayer distance and a weight loss attributable to the organic molecules, as determined by at least one of XRD and TG performed on the obtained dried powder.

The obtained composite that contains a clay mineral and an amine is dispersed in a solvent placed in a container, and the interlayers of the composite are exfoliated by ultrasonic vibration or the like, whereby a nanosheet having a thickness of 10 nm or less is obtained. The method for exfoliating a layered organic-inorganic composite is known. For example, see Backes, T M. et al., Chem. Mater. 2017, 29, 243.

The present disclosure further provides a coating containing any of the flakes described above.

The present inventors found that use of the flakes of the present disclosure, such as nanosheets, makes it possible to obtain a smooth coating that entirely covers a substrate without defects. While the present invention is not intended to be bound by theory, nanosheets that have conventionally been prepared by dispersion in water are dispersed due to electrostatic repulsion, and therefore repulsive forces act between the nanosheets, which has been considered to make it difficult to achieve uniform coating on a substrate. In contrast, according to the present invention, intermolecular interactions act between nanosheets into which an amine has been intercalated. Thus, it is considered that the nanosheets aggregate on a substrate, facilitating formation of a uniform coating. Nanosheets having a thickness of 10 nm or less have flexibility, and the use of such nanosheets enables coating such that a substrate is completely covered without gaps. This is considered to result in a smooth and uniform coating. Such a coating is expected to be applicable as a protective film for various substrates and materials.

The thickness of the coating is, for example, 5 to 2000 nm, preferably 10 to 200 nm.

In some embodiments, the root mean square height (Sq) of the coating is 0.50 μm or less, preferably 0.40 μm or less, and more preferably 0.30 μm or less. A coating having such a root mean square height is excellent in smoothness. The root mean square height is one of the parameters for surface roughness (ISO 25178) and represents the standard deviation of the distance from the mean plane. The root mean square height can be measured, for example, from an image of the coating obtained by a laser microscope.

The present disclosure also provides a method for producing the coating.

The method for producing the coating includes preparing a dispersion containing any of the flakes described above dispersed in a solvent; and applying the dispersion to a base material.

The base material may be any base material, such as a resin, glass, metal, or the like. In a preferred embodiment, the base material includes at least one selected from the group consisting of SiO₂, TiO₂, ZnO, Au, Ni, Pt, and Ag.

The solvent to disperse the flakes is not particularly limited, and may be water, an organic solvent, or a mixed solution thereof. Examples of organic solvents include, but are not limited to, alcohols (e.g., methanol or ethanol), toluene, hexane, ethyl acetate, chloroform, and tetrahydrofuran. These organic solvents may be used alone or in a combination of two or more thereof.

In a preferred embodiment, the solvent includes water.

The dispersion may be applied to a base material by any method, such as drop casting, spin coating, dip coating, spray coating, bar coating, or the like. In terms of simple production of a smooth and thin coating, drop casting and spray coating are preferred, and drop casting is more preferred.

The method for producing the coating may further include removing the solvent from the dispersion applied to the base material. The solvent may be removed by natural drying or by heating to effect evaporation.

The method for producing the coating of the present disclosure is a highly versatile technique that is made applicable by using a day mineral containing a layered compound as a host and selecting an appropriate amine as a guest.

The disclosures of all patent applications and publications cited in this specification are incorporated herein by reference in their entirety.

The following examples are provided for illustrative purposes only and are not intended to limit the technical scope of the present invention in any way. Unless otherwise specified, reagents can be obtained commercially or prepared according to conventional methods or procedures described in known literature in the relevant technical field.

### EXAMPLES

### 1. Reagents

Table 1 shows the reagents used in the present embodiment.

TABLE 1

| | Chemical | | Manufac- |
|---|---|---|---|
| Reagent Name | Formula | Purity/% | turer |
| Clay/montmorillonite | Na_{0.33}(Al_{1.67}Mg_{0.33}) | 98.0 | Kunimine |
| (KUNIPIA-F) | Si₄O₁₀(OH)₂•nH₂O | | Industries |
| | | | Co., Ltd. |
| Tetradecylamine | C₁₄H₃₁N | 96.0 | Tokyo |
| [C₁₄—NH₂] | | | Chemical |
| | | | Industry |
| | | | Co., Ltd. |
| 4-Cyanobenzylamine | C₈H₈N₂•HCl | 98.0 | Tokyo |
| hydrochloride [NTBA] | | | Chemical |
| | | | Industry |
| | | | Co., Ltd. |
| Dioctylamine [DOA] | C₁₆H₃₅N | 96.0 | Tokyo |
| | | | Chemical |
| | | | Industry |
| | | | Co., Ltd. |
| Stearylamine | C₁₈H₃₉N | 85.0 | Tokyo |
| [C₁₈—NH₂] | | | Chemical |
| | | | Industry |
| | | | Co., Ltd. |
| 1-(3-Amino- | C₆H₁₁N₃ | 97.0 | Tokyo |
| propyl)imidazole | | | Chemical |
| [API] | | | Industry |
| | | | Co., Ltd. |
| 4-Fluorobenzylamine | C₇H₈FN | 98.0 | Tokyo |
| [FBA] | | | Chemical |
| | | | Industry |
| | | | Co., Ltd. |
| 4-Aminomethylphenol | C₇H₉NO | 98.0 | Tokyo |
| [OHBA] | | | Chemical |
| | | | Industry |
| | | | Co., Ltd. |
| Diethanol amine | C₄H₁₁NO₂ | 99.0 | Tokyo |
| [DEA] | | | Chemical |
| | | | Industry |
| | | | Co., Ltd. |
| Hydrochloric acid | HCl | 35.0-37.0 | Kanto |
| | | | Chemical |
| | | | Co. Inc. |
| Sulfuric acid | H₂SO₄ | 96.0 | Kanto |
| | | | Chemical |
| | | | Co. Inc. |
| Methanol | CH₄O | 99.8 | Kanto |
| | | | Chemical |
| | | | Co. Inc. |
| Chloroform | CHCl₃ | 99.0% | Kanto |
| | | | Chemical |
| | | | Co. Inc. |
| Ethanol | C₂H₆O | 99.0 | FUJIFILM |
| | | | Wako Pure |
| | | | Chemical |
| | | | Corporation |
| Acetone | C₃H₆O | 99.5 | Kanto |
| | | | Chemical |
| | | | Co. Inc. |
| Tetrahydrofuran | C₄H₈O | 99.5 | Kanto |
| [THF] | | | Chemical |
| | | | Co. Inc. |
| Toluene | C₇H₈ | 99.5 | Kanto |
| | | | Chemical |
| | | | Co. Inc. |
| Benzyl alcohol | C₇H₈O | 99.0 | Kanto |
| | | | Chemical |
| | | | Co. Inc. |

### 2. Synthesis of Layered Organic-Inorganic Composite

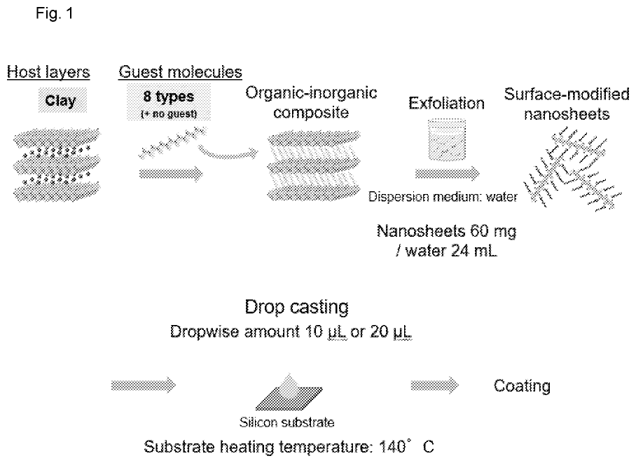

The clay contains a layered compound. Thus, XRD was performed on commercially available clay powder. The clay serving as host layers was intercalated with 8 types of organic amines as guest compounds to produce an organic-inorganic composite (FIG. 1). First, clay with a CEC of 2.80 mequiv. (corresponding to 2.602 g of the clay used in this experiment) was added to 200 cm³ of pure water, followed by stirring at 60° C. for several hours to allow the clay to completely swell. Separately, 2.80 mmol of organic molecules was added to about 20 cm³ of pure water, and 2.80 mmol of hydrochloric ad was further added to produce a guest solution in which various amines were ionized. The guest solution was added all at once to the clay dispersion, followed by stirring at 60° C. for 5 hours. Subsequently, to wash unincorporated salts and organic molecules, the mixture was subjected to centrifugation using a mixed solvent of water and ethanol (3000 rpm, 10 min) twice and centifugation using a mixed solvent of ethanol and THF (3000 rpm, 10 min) twice. The sediment was dried to give a clay organic-inorganic composite (Guest-Clay). The obtained powder was analyzed by XRD and TG to identify whether the composite was successfully formed based on an increase in interlayer distance and a weight loss attributable to the organic molecules.

### 3. Production of Nanosheets

### 3-1. Exfoliation in Benzyl Alcohol

100 mg of the clay incorporating the guest molecules, which was obtained in Section “2. Synthesis of Layered Organic-Inorganic Composite,” was weighed out and placed in a 50 cm³ sample tube. 20 cm³ of benzyl alcohol as a dispersion medium was added thereto, and a homogenizer was immersed in this liquid. While the sample tube was surrounded with cold water for cooling, homogenization was performed for 15 minutes, and the layers of the composite were exfoliated. After stirring, the bulk was removed by filtration through a 2 μm filter, and the filtrate was used as the dispersion of each sample (FIG. 1). Dynamic light scattering (DLS) of the dispersion was also performed as appropriate. Subsequently, the dispersion was subjected to suction filtration, and the residue was dried under vacuum at room temperature in a vacuum desiccator for at least one day to recover the nanosheet powder.

### 3-2. Exfoliation in Pure Water

60 mg of the clay incorporating the guest molecules, which was obtained in Section “2. Synthesis of Layered Organic-Inorganic Composite,” was weighed out and placed in a 50 cm³ sample tube. 24 cm³ of water as a dispersion medium was added thereto, and a homogenizer was immersed in this liquid. While the sample tube was surrounded with cold water for cooling, homogenization was performed for 15 minutes, and the layers of the composite were exfoliated. After stirring, the bulk was removed by filtration through a 2 μm filter, and the filtrate was used as the dispersion of each sample (FIG. 1). Dynamic light scattering (DLS) of the dispersion was also performed as appropriate. The obtained dispersion was used to produce a thin film by drop casting.

### 4. Coating on Substrate

### 4-1. Thin Film Production by Spray Coating

The nanosheets obtained in Section “3. Production of Nanosheets” were dispersed in methanol, and the container was then capped and immersed in an ultrasonic cleaner (BRANSON 2510, available from Yamato Scientific Co., Ltd.) for 30 minutes to prepare a nanosheet dispersion. The dispersion was placed in a spray bottle. After glass substrates were laid out on a table, spray coating was performed at intervals of 30 to 60 seconds from a position 20 cm horizontally and 10 cm vertically from each substrate. Spray coating was repeated until the dispersion was used up. This procedure was regarded as one set of coating.

The coating was subjected to contact angle measurement, laser microscope (LM) observation, and scanning electron microscope (SEM) observation. The contact angle was measured using an 8 μL droplet of water.

### 4-2. Production of Thin Film by Drop Casting

The nanosheet aqueous dispersion obtained in Section “3. Production of Nanosheets” was drop-cast to Si substrates as base materials to produce multilayer nanosheet films. Si substrates of about 5 to 10 mm square were provided, washed with acetone, and placed on a hot stage. The hot-stage temperature was set to about 40° C. higher than the boiling point of the solvent (Table 2). After the Si substrates were left for at least 1 minute to be sufficiently heated, the nanosheet dispersion was drop-cast (FIG. 1). For the Si substrates subjected to drop casting repeatedly, the dispersion was dropped again to the remaining portions of the nanosheet films after the dispersion medium on the Si substrate had completely evaporated.

4-2-1. Drop Casting using Dispersion Medium Containing Methanol

Regarding the nanosheet concentration relative to the dispersion medium, in some experiments, the concentration was the same as that used for the spray coating samples (nanosheets 45 mg/methanol 3 mL or toluene 9 mL), whereas in other experiments, the concentration was very low (nanosheets 4 mg/dispersion medium 10 mL).

4-2-2. Drop Casting after Exfoliation in Water

For the Guest-Clay, experiments were also conducted in which drop casting was performed after exfoliation in water. After exfoliation, the bulk was removed by filtration through a syringe filter with a pore size of 2 μm, and the filtrate was directly drop-cast. The nanosheets were prepared by incorporating 8 types of amines (4-cyanobenzylamine hydrochloride (NTBA), dioctylamine (DOA), stearylamine (C₁₈—NH₂), tetradecylamine (C₁₄—NH₂), 1-(3-aminopropyl)imidazole (API), 4-fluorobenzylamine (FBA), 4-aminomethylphenol (OHBA), and diethanol amine (DEA); or 9 types of nanosheets, including one without incorporation of guest molecules) separately into day serving as host layers. These nanosheets were drop-cast onto the respective silicon substrates.

The contact angle was measured using a 3 μL droplet of water in each case.

TABLE 2
Hot-Stage Temperature during Drop Casting

| | | Boiling | Hot-stage temperature |
|---|---|---|---|
| Solvent name | Formula | Point/° C. | setting/° C. |
| Methanol | CH₃OH | 64.7 | 100 |
| Toluene | C₆H₅CH₃ | 110.6 | 150 |
| Water | H₂O | 100.0 | 140 |

### 5. Analysis Method

### 5-1. X-Ray Diffraction (XRD)

The powder sample was compressed into a sample holder, and X-ray diffraction was performed using an X-ray diffractometer (D8 Advance, available from Bruker) by continuous scanning with Cu Kα radiation. The interlayer distance was calculated from the shift of peaks corresponding to the interlayer spacing of the {001} plane and the like using Bragg's law shown below, and the presence or absence of intercalation of organic molecules into the interlayer was determined from the expansion of the interlayer distance.

$$Bragg ' s law : 2 d sin θ = n λ ( n = 1 )$$

d: Crystal plane spacing (nm); λ X-ray wavelength (0.1542 nm); θ: diffraction angle

### 5-2. Thermogravimetry-Differential Thermal Analysis (TG-DTA)

To investigate the organic content in the sample, measurements were performed over a temperature range from room temperature to 800° C., using TG-DTA (EXSTER, TG/DTA7200, available from Yamato Scientific Co., Ltd.). The temperature was increased at 10° C. min⁻¹. Assuming that the weight loss up to 200° C. was due to adsorbed water and that the weight loss above 200° C. was attributable to the organic molecules, the amount of incorporated organic molecules was calculated.

### 5-3. Scanning Electron Microscope (FE-SEM)

FE-SEM (S-4700, available from Hitachi, Ltd.) observation was performed after the sample was fixed to a sample table with a conductive tape and coated with osmium by vapor deposition for 10 seconds. FE-SEM was used to observe the organic molecule composite serving as a precursor prior to exfoliation and to measure its primary particle size to determine the filter size. It was also used to observe the surface state of the multilayer nanosheet film produced.

### 5-4. Dynamic Light Scattering (DLS)

For the dispersion after exfoliation, the particle size distribution of nanosheets in the dispersion was evaluated by dynamic light scattering, using a zeta-potential, particle size, and molecular weight measurement system (ELSZ-2000ZS available from Otsuka Electronics Co., Ltd.). The number of accumulations in the measurement was 100. The nanosheet size was estimated from the average particle size Lₐᵥₑ and the standard deviation σ of the particle size distribution obtained in the measurement.

### 5-5. Transmission Electron Microscope (FE-TEM)

The nanosheets obtained by exfoliation were observed using FE-TEM (FEI, Tecnai G2). An observation sample was prepared by dropping 20 μL of the nanosheet dispersion, diluted as necessary, onto a collodion-coated microgrid.

### 5-6. Atomic Force Microscope (AFM)

The nanosheets obtained by exfoliation were observed using AFM (SPM9600, available from Shimadzu Corporation). A hot plate was heated to 250° C., which is higher than the boiling point of the dispersion medium (benzyl alcohol) of the nanosheet dispersion, and the silicon substrates were placed on the hot plate. Observation substrates were prepared by dropping 10 μL of the dispersion, diluted as necessary, onto the silicon substrates and evaporating the solvent. AFM observations were performed in dynamic mode.

### 5-7. Laser Microscope (LM)

To analyze the surface roughness of the multilayer nanosheet films, the surface roughness was measured using a laser microscope (VK-X1000, available from Keyence). The root mean square height (Sq) was measured as the surface roughness. The magnification used for measurement was 50× for the films prepared by spray coating and 150× for the films prepared by drop casting.

### 5-8. Contact Angle Meter

The water repellency of the surface of each substrate produced was measured using a contact angle meter (DropMaster, available from Kyowa Interface Science Co., Ltd.). Measurements were performed using multifunctional integrated analysis software (FAMAS, available from Kyowa Interface Science). Water was dispensed from a syringe to form droplets of 8 μL or 3 μL at the tip. The substrate was brought closer to the droplets, and the adhered droplet was photographed to measure the contact angle. For the same substrate, three measurements were performed at different droplet positions. Using the values of the left and right contact angles of the photographed droplets, the average and standard deviation of a total of six data sets were calculated. These values were used as the contact angles of the thin films.

### 6. Results

### 6-1. Confirmation of Layered Organic-Inorganic Composite

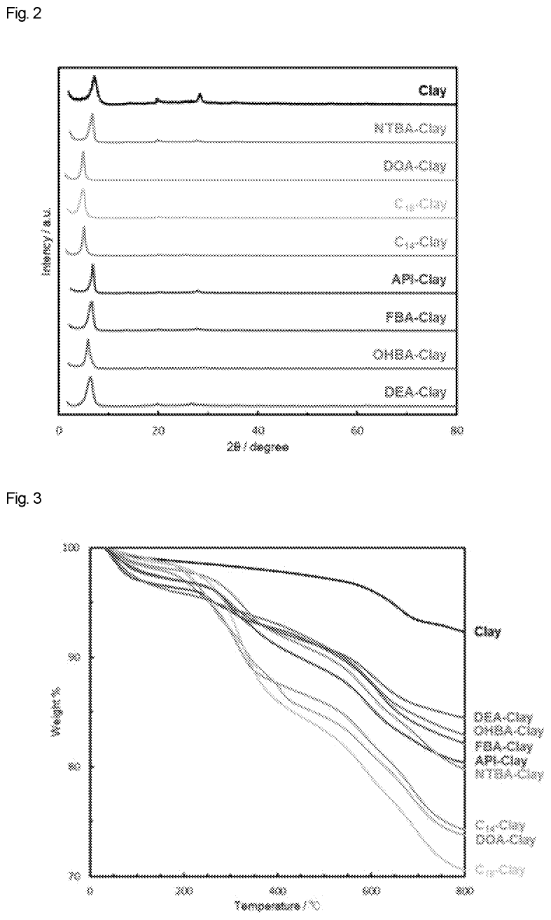

FIG. 2 and FIG. 3 respectively show XRD and TG of the clay incorporating the guest molecules, which was produced in Section “2. Layered Organic-Inorganic Composite.”

A low-angle shift of the interlayer peak in XRD and a mass loss in TG were observed after incorporation of each amine, as compared with before incorporation, confirming the incorporation of the organic molecules. Table 3 shows the interlayer distances calculated from XRD.

TABLE 3
Interlayer Distance of Clay Before
and After Incorporation of Guest

| Composite | Interlayer Distance d/nm |
|---|---|
| Clay | 1.24 |
| NTBA-Clay | 1.31 |
| DOA-Clay | 1.80 |
| C₁₈-Clay | 1.80 |
| C₁₄-Clay | 1.73 |
| API-Clay | 1.29 |
| FBA-Clay | 1.31 |
| OHBA-Clay | 1.51 |
| DEA-Clay | 1.37 |

### 6-2. Confirmation of Nanosheets

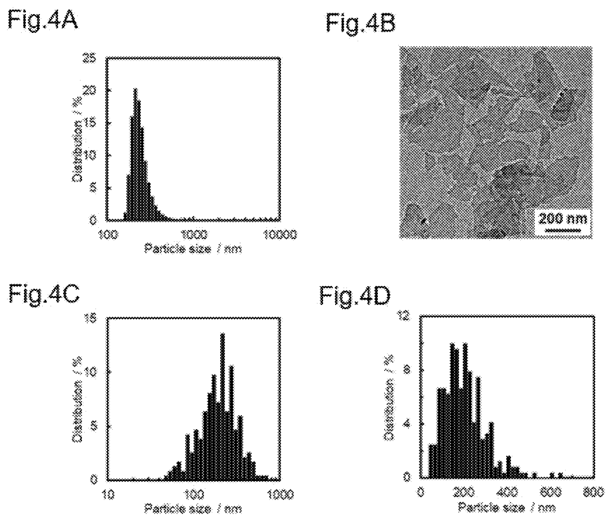

C₁₄-Clay was exfoliated in benzyl alcohol, and the exfoliated product was observed. To confirm the lateral size of the obtained exfoliated product, measurements were performed using dynamic light scattering (DLS) and transmission electron microscopy (TEM). FIGS. 4A to 4D show the results.

The size was 237±65 nm as measured by DLS, and 208±100 nm as measured by TEM. The results were almost the same. In the following, the values obtained by TEM are used as the lateral size.

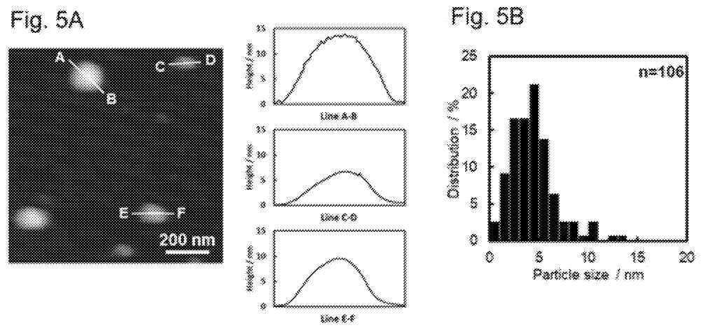

To confirm the thickness of the obtained exfoliated product, measurement was performed by atomic force microscopy (AFM). FIGS. 5A to 5B show the results.

The thickness was 4.38±2.40 nm as measured byAFM.

The above results show that the exfoliated product has a small thickness relative to the lateral dimensions, indicating a high aspect ratio. In other words, it was confirmed to be a nanosheet.

### 6-3. Thin Film Production by Spray Coating

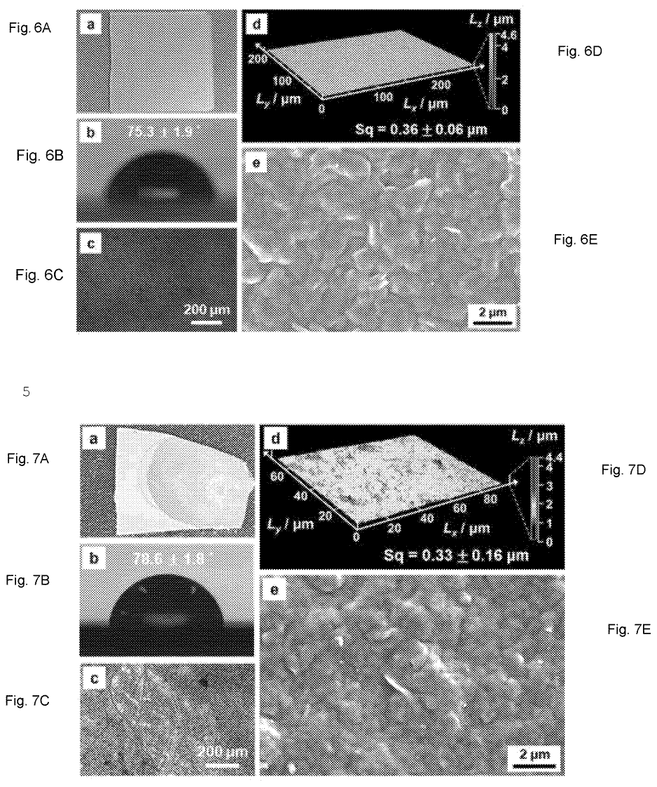

A film subjected to one set of spray coating of C₁₄-Clay nanosheets that were confirmed to be successfully synthesized in Section 6-2 had a thickness of 4.37±2.40 nm and a contact angle of 75.3±1.9°. LM images confirmed an extremely flat surface on a macroscopic scale, and SEM images confirmed an extremely flat surface on a microscopic scale (FIGS. 6, (a) to (e)).

### 6-4. Production of Thin Film by Drop Casting

The films obtained by drop casting clay nanosheets incorporating amines can be broadly classified into two types. The first type is a sample that, as described in Section 3-1, was subjected to exfoliation with benzyl alcohol, followed by suction filtration, drying, re-dispersion in methanol, and drop casting. The second type is a sample that, as described in Section 3-2, was subjected to exfoliation with water, followed by drop casting in the form of an aqueous dispersion without suction filtration or the like. The results are described in each section.

### 6-4-1. C₁₄-Clay Nanosheets Dispersed in Methanol

C₁₄-Clay nanosheets were dispersed in methanol and drop-cast onto a silicon substrate. A film was produced by dropping 10 μL of the dispersion (nanosheets 45 mg/methanol 3 mL) twice. This film had a contact angle of 78.6±1.8°. LM images confirmed an extremely flat surface on a macroscopic scale, and SEM images confirmed an extremely flat surface on a microscopic scale (FIGS. 7, (a) to (e)).

A sample diluted to a specific nanosheet concentration (nanosheets 4 mg/methanol 10 mL) was also drop-cast. Similarly to the above, LM images confirmed an extremely flat surface on a macroscopic scale, and SEM images confirmed an extremely flat surface on a microscopic scale (data not shown).

### 6-4-2. Water-Exfoliated Guest-Clay Nanosheets

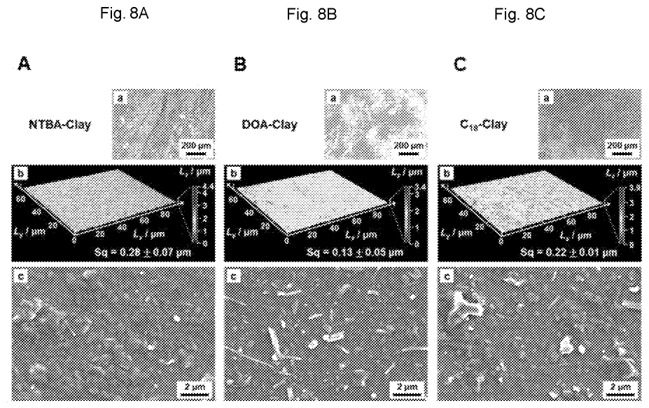

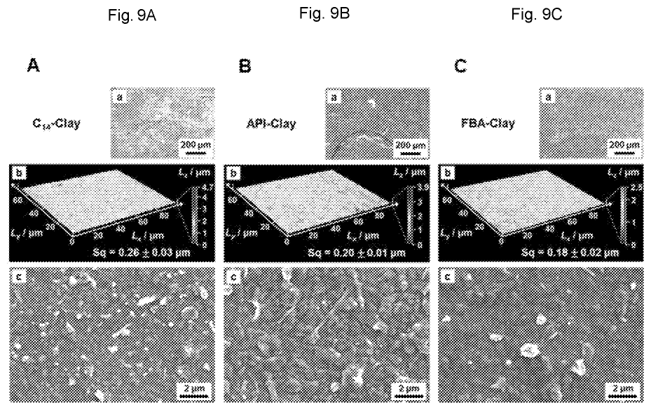

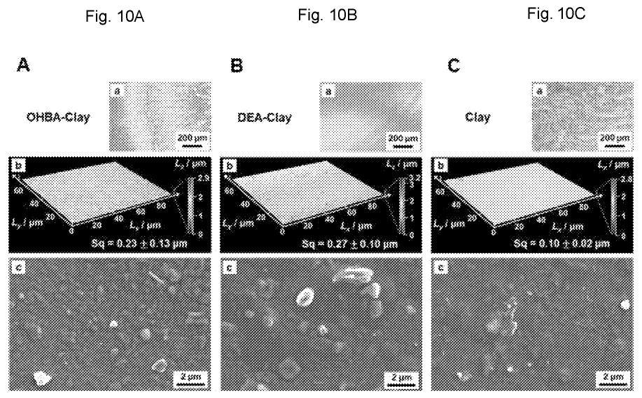

Water-exfoliated Guest-Clay nanosheets were drop-cast. The nanosheet percent yield varies depending on the guest. Thus, the concentration was excessively high in some cases and excessively low in other cases. The dispersions having an excessively high concentration were diluted by adding water after exfoliation and filtration (Table 4). The dispersions having an excessively low concentration were drop-cast several times to increase the amount of nanosheets deposited on the silicon substrate. While all of the obtained films exhibited structural color, they differed in terms of the presence or absence of angular dependence. FIGS. 8 to 10 show a total of 9 optical microscope images, a total of 9 LM images, and a total of 9 SEM images of the obtained films.

TABLE 4
Experimental Conditions for Films Prepared by
Drop Casting Pure Water-Exfoliated Guest-Clay

| | Concentration | | Number of | |
|---|---|---|---|---|
| | (nanosheets/ | Dropwise | drops/ | Angular |
| Nanosheets | water) | amount/μL | times | dependence |
| NTBA-Clay | 6.0 mg/24 mL | 20 | 10 | Absent |
| DOA-Clay | 60 mg/24 mL | 20 | 15 | Absent |
| C₁₈-Clay | 60 mg/24 mL | 20 | 25 | Absent |
| C₁₄-Clay | 60 mg/24 mL | 20 | 75 | Absent |
| API-Clay | 60 mg/24 mL | 20 | 1 | Absent |
| FBA-Clay | 12 mg/24 mL | 20 | 1 | Absent |
| OHBA-Clay | 60 mg/24 mL | 10 | 1 | Present |
| DEA-Clay | 60 mg/24 mL | 10 | 1 | Present |
| Clay | 60 mg/24 mL | 10 | 1 | Present |

In all cases, fairly flat films were obtained, and the LM results confirmed that the surface roughness on the macroscopic scale was 0.30 μm or less. The SEM results confirmed that the films with angular dependence had slightly flatter surfaces than those without angular dependence.

In selecting the guest, the present inventors hypothesized that nanosheets with a broad size distribution, i.e., polydisperse nanosheets, are likely to generate minute irregularities and thus produce films without angular dependence, whereas nanosheets with a small size distribution, i.e., monodisperse nanosheets, are stacked very smoothly and thus produce films with angular dependence. With this hypotheses, of the 798 conditions in the size distribution prediction model (21 types of guest molecules and 38 types of dispersion media), the present inventors limited the dispersion medium to water and selected 6 types with the highest ranking on the polydisperse side (NTBA, DOA, C₁₈—NH₂, C₁₄—NH₂, API, and FBA) and 2 types with the lowest ranking on the monodisperse side (OHBA, DEA). The dispersion medium was limited to water in order to facilitate observation of changes arising from differences in guest molecules in the same dispersion medium. From the results in Table 4, it can be concluded that the discussion on the presence or absence of angle dependence, based on the nanosheet size distribution prediction model, is valid.

As shown in Table 4, the conditions, such as concentration, required for the appearance of structural color varied, and the reasons are considered to arise from variations in the percent yield of nanosheets obtained by exfoliation. Therefore, the percent yield was examined by suction filtration of each nanosheet dispersion. Table 5 shows the results.

TABLE 5
Percent Yield of Water-Exfoliated Guest-Clay Nanosheets

| Composite/dispersion medium | Nanosheet yield/mg | Nanosheet percent |
|---|---|---|
| for exfoliation | (in 60 mg) | yield/% |
| NTBA-Clay/H₂O | 18.492 | 30.8 |
| DOA- Clay/H₂ | 1.139 | 1.90 |
| C₁₈-Clay/H₂O | 1.276 | 2.13 |
| C₁₄-Clay/H₂O | 0.212 | 0.35 |
| API-Clay/H₂O | 8.373 | 14.0 |
| FBA-Clay/H₂O | 44.528 | 74.2 |
| OHBA-Clay/H₂O | 52.693 | 87.8 |
| DEA-Clay/H₂O | 55.898 | 93.2 |
| Clay/H₂O | 45.651 | 76.1 |

It was confirmed that the nanosheet percent yield differed significantly.

1. A compound comprising a composite containing a clay mineral and an amine, and having a thickness of 10 nm or less.

2. The flake according to claim 1, wherein the flake is a nanosheet.

3. The flake according to Item 1, wherein the amine comprises an amine selected from the group consisting of an optionally substituted benzylamine, an optionally substituted alkylamine, an optionally substituted dialkylamine, an optionally substituted aminoalkylimidazole, an optionally substituted aminoalkylphenol, an optionally substituted amino alcohol, and salts of any of the foregoing.

4. The flake according to claim 1, wherein the clay mineral comprises clay.

5. A coating comprising the flake according to claim 1.

6. The coating according to claim 5, wherein the coating has a root mean square height of 0.50 m or less.

7. A method for producing a coating, comprising:
preparing a dispersion comprising a plurality of flakes according to claim 1 dispersed in a solvent; and
applying the dispersion to a base material.

8. The method according to claim 7, wherein the applying comprises applying by drop casting, spin coating, dip coating, spray coating, or bar coating.
